(19) United States
(12) Patent Application Publication
(10) Pub. No.: US 2009/0092233 A1
(43) Pub. Date: Apr. 9, 2009

(54) Method of and System for Updating Mobile Telephone Contact List Entries

(76) Inventors: Henri Fouotsop Meli, Cary, NC (US); Stephanie Lee Walter, Morrisville, NC (US); Tong Yu, Cary, NC (US); Yingxin Xing, Durham, NC (US)

Correspondence Address: DILLON & YUDELL LLP, 8911 N. CAPITAL OF TEXAS HWY., SUITE 2110, AUSTIN, TX, 78759, US

(21) Appl. No.: 11/867,287

(22) Filed: Oct. 4, 2007

(51) Int. Cl. H04M 1/64

(52) U.S. Cl. 379/88.11

(57) ABSTRACT

A mobile telephone and a method of updating mobile telephone contact list entries automatically sends a new contact information notification text message to selected contact mobile phone numbers. The mobile telephone automatically updates an entry in its contact list in response to receiving a new contact information notification text message from another mobile telephone.

### BACKGROUND OF THE INVENTION

1. Technical Field

The present invention relates generally to the field of mobile devices, and more particularly to a mobile telephone that can broadcast new contact information, such as a new telephone number, to contacts stored in the mobile phone and, upon receipt of a new contact information notification, update its contact list with the new telephone number.

2. Description of the Related Art

Mobile communication devices, such as cellular telephones, have become very common among the general public. With advances in technology, the costs of mobile communication equipment and services are continually being reduced. Mobile carriers offer various plans and packages and subscribers can pick among various carriers and plans so as to minimize their costs. While some mobile carriers offer telephone number portability, whereby a subscriber can keep his or her olds telephone number when changing carriers, other carriers do not offer number portability services. Also, with the rapid increase in the number of telephones, both a land line and mobile, and pagers, many calling areas are running out of numbers. Accordingly, a subscriber may be required to change his or her telephone number.

One of the features offered on most mobile telephones is a contact list or address book. The contact list stores telephone numbers for the contacts listed in the subscriber's address book. The contact list enables the subscriber to call his or her contacts without having to remember and dial the contacts telephone number.

Currently, when a subscriber changes gets a new mobile telephone, the subscriber can import into the new telephone his or her contacts list into the new mobile telephone. However, the subscriber cannot conveniently notify his or her contacts of a new telephone number or other new contact information.

### SUMMARY OF THE INVENTION

The present invention provides a mobile telephone and a method of updating mobile telephone contact list entries. Embodiments of mobile phones according to the present invention include a memory having a contact list stored therein. The contact list includes a plurality of entries. Each entry includes a contact name and contact information, such as a contact mobile telephone number. The mobile telephone sends a new contact information notification text message to selected contact mobile phone numbers. The mobile telephone automatically updates an entry in its contact list in response to receiving a new contact information notification text message from another mobile telephone.

In embodiments of the mobile telephone according to the present invention, the mobile telephone displays a new contact information notification dialog. The new contact information notification dialog may include an old information entry field, a new information entry field, and an affirmative choice control. The mobile telephone creates the new contact information notification text message in response to actuation of the affirmative choice control. Also in response to actuation of the affirmative choice control, the mobile telephone displays the contact list including a select all control and an individual selection control. If the user actuates the select all control, the mobile telephone sends the new contact information notification text message to each contact mobile telephone number in the contact list. If the user actuates the individual selection control, the mobile telephone sends the new contact information notification text message to selected contact mobile telephone numbers in the contact list.

The mobile telephone automatically updates its contact list by displaying a new contact information notification text message with an update control. If the mobile telephone user actuates the update control, the mobile phone updates an entry in its contact list based upon information in the new contact information notification text message.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a mobile telephone according to the present invention;

FIG. 2 is an illustration of an embodiment of a contacts menu according to the present invention;

FIG. 3 is an illustration of an embodiment of a number change dialog according to the present invention;

FIG. 4 is an illustration of an embodiment of a contact list according to the present invention;

FIG. 5 is an illustration of an embodiment of a number change notification text message according to the present invention;

FIG. 6 is a flow chart of an embodiment of sending mobile telephone processing according to the present invention;

FIG. 7 is a flow chart of an embodiment of receiving mobile telephone processing according to the present invention; and,

FIG. 8 is a block diagram of a typical cellular telephone system.

### DETAILED DESCRIPTION OF THE PREFERRED EMBODIMENT

Referring now to the drawings, and first FIG. 1, an embodiment of a mobile telephone according to the present invention is designated generally by the numeral 100. Mobile telephone 100 includes a controller 101 that is programmed according to the present invention, as well as to perform other mobile device functions. Mobile telephone 100 includes a keypad 103 and the display 105, each coupled to controller 101. As is known to those skilled the art, keypad 103 includes various keys for entering telephone numbers and performing typical mobile telephone operations as well as operations according to the present invention. Display 105 may be a liquid crystal or other display commonly used in mobile devices. Mobile telephone 100 includes a speaker 107 and a microphone 109 coupled to controller 101. Mobile device 100 includes a radio 111 coupled to controller 101. Mobile telephone 100 includes a memory 113 coupled to controller 101. Mobile telephone 100 includes a subscriber identity module (SIM) card 121 coupled to controller 101. As is known to those skilled in the art, SIM card 121 is a removable smart card that stores subscriber information. Mobile telephone 100 may preferably be housed in any number of conventional cellular telephone cases.

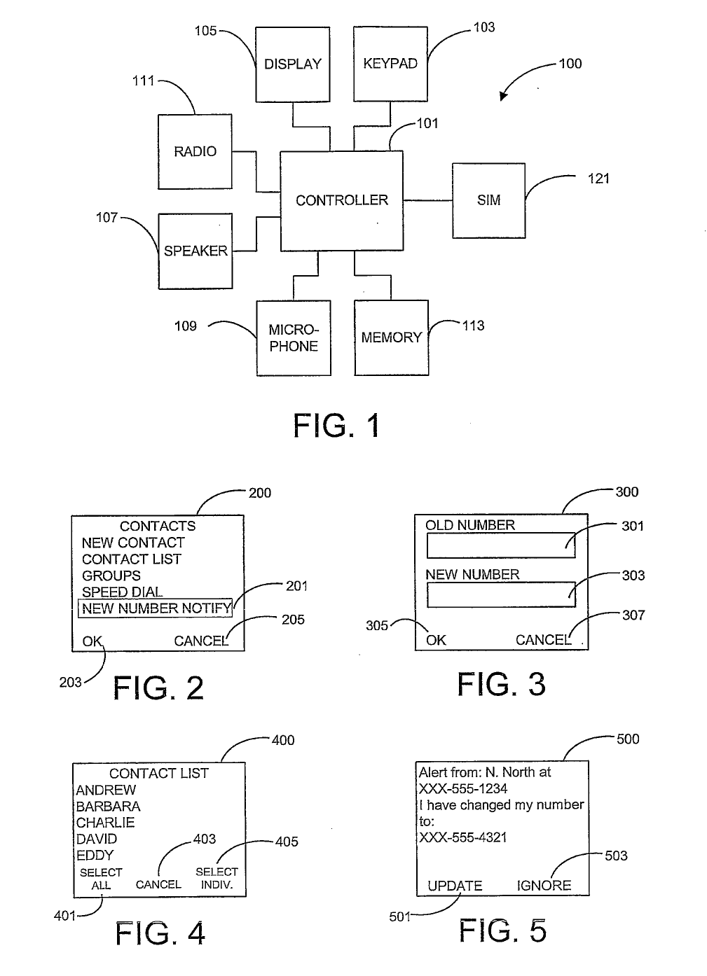

FIG. 2 illustrates an embodiment of a contacts menu 200 according to the present invention. Contacts menu 200 is displayed on display 105 of mobile telephone 100. Contacts menu 200 allows a mobile telephone user to manage his or her contact list or address book. According to the present invention, contacts menu 200 includes a new number notify menu choice 201. New number notify menu choice 201 allows a mobile telephone user to notify contacts in his or her contact list when the mobile telephone user changes his or her mobile telephone number. While new number notification is illustrated herein, it should be recognized that embodiments on the present invention may be used to update other contact information, such as email address, secondary mobile phone number, home phone number, etc. In a manner well known to those skilled in the art, a mobile telephone user can scroll through the menu item choices of contacts menu 200 to highlight new number notify menu choice 201. Contacts menu 201 includes an OK soft key 203 and a CANCEL soft key 205. Soft keys 203 and 205 may be actuated by pushing buttons (not shown) on keypad 103.

Actuation of OK soft key 203 causes mobile telephone 100 to display a number change dialog 300, as shown in FIG. 3. Number change dialog 300 includes an old number entry field 301 and the new number entry field 303. In the illustrated embodiment, since the user may notify contacts of a number change it using either the mobile associated with the old number or the new number, or a mobile phone not associated with either the old number or the new number, the user enters both the old mobile telephone number and the new mobile telephone number. Number change dialog 300 includes an OK soft key 305 and a CANCEL soft key 307. According to the present invention, mobile telephone 100 uses the numbers entered into entry field 301 and 303 to create a text message of the type illustrated in FIG. 5.

Actuation of OK soft key 305 causes mobile telephone 100 to display a contact list 400. Contact list 400 includes each contact in the address book of mobile telephone 100. Contact list 400 includes a SELECT ALL soft key 401, a CANCEL soft key 403, and a SELECT INDIVIDUAL soft key 40 soft key 405. Actuation of SELECT ALL soft key 401 causes mobile telephone 100 to send a telephone number change notification text message to the mobile telephone of each contact listed in contact list 400. Actuation of SELECT INDIVIDUAL soft key 405 causes mobile telephone 100 to send a telephone number change notification text message to the mobile phones of selected contacts listed in contact list 400.

FIG. 5 illustrates a number change notification text message 500 displayed on a receiving mobile telephone. Number change notification text message 500 identifies the sender, and it includes the sender's old telephone number and the sender's new telephone number. Number change notification text message 500 includes an UPDATE soft key 501 and an IGNORE soft key 503. As will be explained in detail hereinafter, actuation of update soft key 501 causes the mobile telephone to update its contact list with information contained in number change notification text message 500. Actuation of ignore soft key 503 causes the mobile telephone to ignore number change notification text message 500.

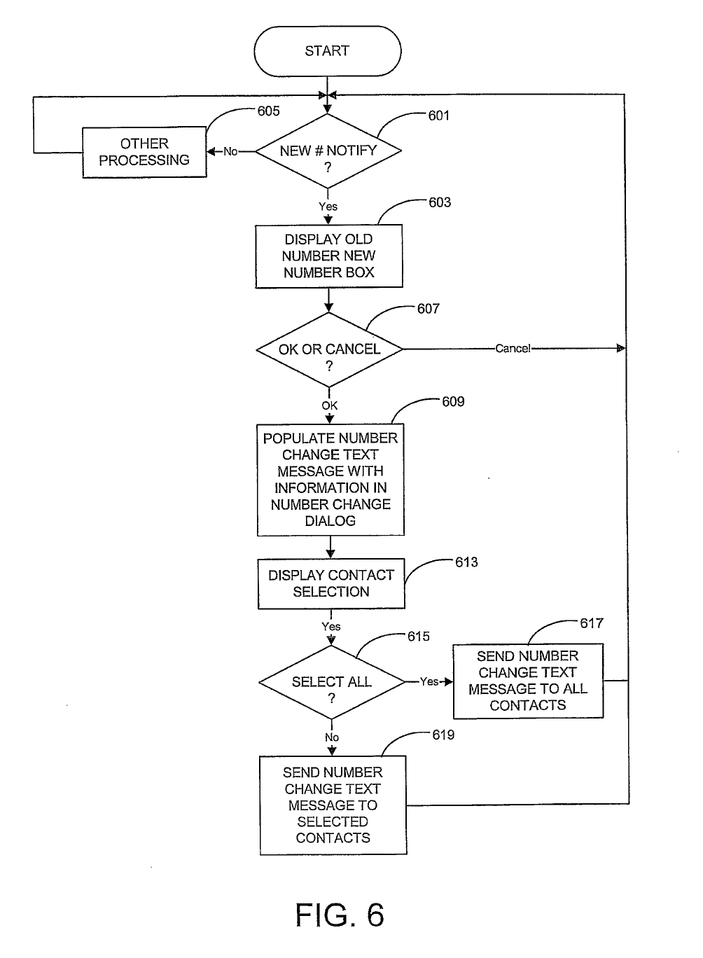

FIG. 6 is a flow chart of an embodiment of sending mobile telephone processing according to the present invention. The mobile telephone waits for user input and if, as determined at decision block 601, the user input is new number notify, the mobile telephone displays the number change dialog, as indicated at block 603, and waits for user input. If the input is not new number notify, the mobile telephone performs other processing, as indicated at block 605. If, as determined at decision block 607, the user input is OK, the mobile telephone populates a number change text message shell with information in the number change dialog, as indicated at block 609. Then, the mobile telephone displays a contacts selection list, as indicated at block 613, and waits for user input. If, as determined at decision block 615, the user input is SELECT ALL, the mobile telephone sends a number change notification text message to all contacts in the user's address book, as indicated at block 617. If, as determined at decision block 615, the user input is not SELECT ALL, the mobile telephone sends the number change notification text message to selected contacts.

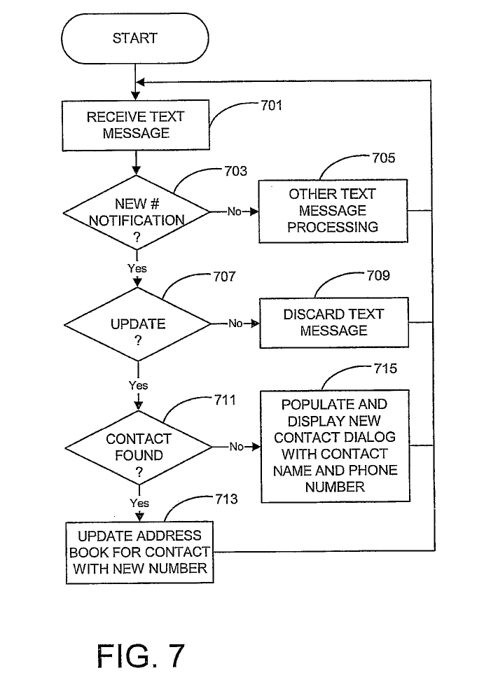

FIG. 7 is a flow chart of an embodiment of receiving mobile telephone processing according to the present invention. The receiving mobile telephone receives a text message, as indicated at block 701. If, as determined at decision block 703, the received text message is not a new number notification, the receiving mobile telephone performs other text messaging processing, as indicated at block 705. If, as determined at decision block 703, the received text message is a new number notification, the mobile telephone waits for user input. If, as determined at decision block 707, the user input is not UPDATE the mobile telephone discards the text message, as indicated at block 709. If the user input is UPDATES, the mobile telephone determines, at decision block 711 if the sender of the new number notification text message is found in the address book of the receiving mobile phone. If so, the receiving mobile telephone updates its address book for the contact with the new number, as indicated at block 713. If, as determined at decision block 711, the contact is not found, the receiving mobile telephone performs new contact processing by populating and displaying a new contact dialog with contact name and telephone number information contained in the new number notification text message, as indicated at block 715.

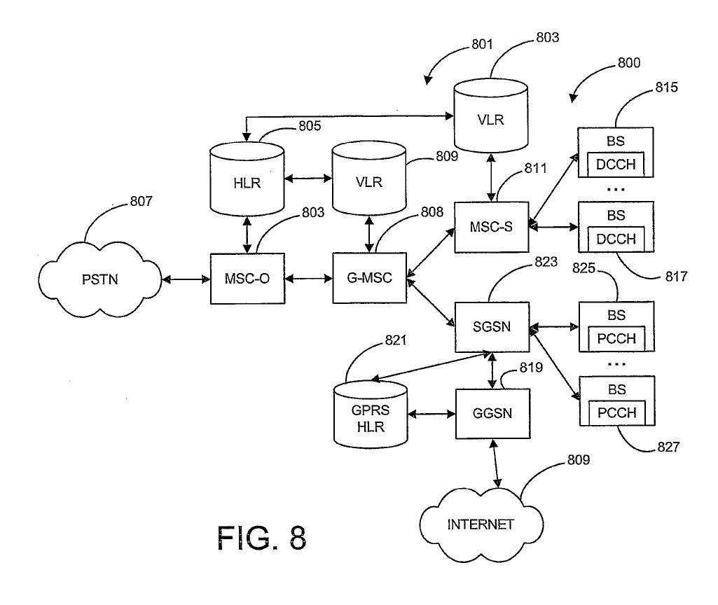

FIG. 8 is a block diagram of a typical mobile network 800. Mobile network 800 includes a packet radio service (e.g., GPRS, EDGE, CDMA) system 801. Packet radio service system 801 enables a mobile device, such as mobile device 100, to access both a data network, such as the Internet 809, and a public switched telephone network (PSTN) 807. An originating mobile switching center (MSC-O) 803 provides an interface mobile network 800 and PSTN 807. In one embodiment where the packet radio service is GPRS, a home location register (HLR) 805 provides MSC-O 803 subscriber and location information for the mobile devices in its home area. A gateway mobile switching center (G-MSC) 808 is connected to MSC-0 803 and a visitor location register (VLR) 809. VLR 809 provides location information to HLR 805. A servicing mobile switching center (MSC-S) 811 is connected to G-MSC 808 and a VLR 813. VLR 813 provides location information to HLR 805. MSC-S 811 is connected to a plurality of base stations, including base stations 815 and 817, which use digital control channels (DCCHs) for paging and registration of mobile units and their respective areas.

A gateway GPRS support node print (GGSN) 819 provides an interface between Internet 809 and mobile network 803. A GPRS HLR 821 provides GGSN 819 with location and subscriber information. GGSN 819 and GPRS HLR 821 are in communication with a servicing GPRS support node (SGSN) 823, which communicates with mobile devices in its area through a plurality of base stations, including base stations 825 and 827. Base stations 825 and 827 use packet control channels (PCCHs) for paging and registration of mobile units in their respective areas.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method of updating mobile telephone contact list entries, which comprises:
creating, on a first mobile telephone, a text message, said text message including new contact information for a contact;
displaying a contact list for said first mobile telephone;
in response to selection of an addressee from said contact list for said first mobile telephone, sending said text message from said first mobile telephone to a second mobile telephone for said addressee;
displaying said text message and an update choice on said second mobile telephone; and,
in response to selection of said update choice, updating a contact list of said second mobile telephone with said new contact information for said contact.

2. The method as claimed in claim 1, wherein said creating said text message comprises:
displaying on said first mobile telephone a contact information change dialog, said contact information change dialog including old contact information for said contact and said new contact information and an affirmative choice; and,
creating said text message in response to selection of said affirmative choice.

3. The method as claimed in claim 1, further comprising:
displaying a select all choice in connection with said contact list for said first mobile telephone; and,
in response to selection of said select all choice, sending said text message from said first mobile telephone to a mobile telephone for each addressee in said contact list.

4. The method as claimed in claim 1, wherein said new contact information comprises a new mobile telephone number.

5. The method as claimed in claim 4, wherein said creating said text message comprises:
displaying on said first mobile telephone a new mobile telephone number change dialog, said number change dialog including an old mobile telephone number for said contact and said new mobile telephone number and an affirmative choice; and,
creating said text message in response to selection of said affirmative choice.

6. A method of updating cellular telephone contact list entries, which comprises:
providing, on a first mobile telephone, a new contact information notification menu choice;
in response to selection of said new contact information notification menu choice, creating a text message, said text message including new contact information for an individual associated with said first mobile telephone;
sending said text message to at least one second mobile telephones associated with a contact in a contact list for said first phone;
receiving said text message at said at least one second mobile telephone; and,
automatically updating a contact list for said at least one second mobile telephone with said new contact information.

7. The method as claimed in claim 6, wherein said creating said text message comprises:
displaying, on said first mobile telephone, a new contact information notification dialog, said new contact information dialog including a new contact information entry field and an affirmative choice; and,
in response to entering new contact information in said new number entry field and selection of said affirmative choice, creating said text message.

8. The method as claimed in claim 7, wherein said sending said text message comprises:
in response to selection of said affirmative choice, displaying said contact list for said first mobile telephone, said contact list comprising a plurality of entries, each entry including a contact name, each said name being associated with a contact mobile telephone number;
displaying in association with displaying said contact list for said first mobile telephone a select all choice and an individual selection choice;
in response to selection of said select all choice, sending said text message to the contact mobile telephone number associated with each said contact name; and,
in response to selection of said individual selection choice, sending said text message to the contact mobile telephone number associated with a selected contact name.

9. The method as claimed in claim 8, wherein said automatically updating said contact list for said at least one second mobile telephone comprises:
displaying said text message on said at least one mobile telephone;
displaying in association with said text message an update choice and an ignore choice;
in response to selection of said update choice, updating an entry for said individual associated with said first mobile telephone; and,
in response to selection of said ignore choice, terminating displaying said text message without updating said entry for said individual.

10. The method as claimed in claim 6, wherein said new contact information comprises a new mobile telephone number.

11. A mobile telephone, which comprises:
a memory, said memory having stored therein a contact list, said contact list comprising a plurality of entries, each entry comprising a contact name and contact information;
means for sending a new contact information notification text message to selected contact mobile telephone numbers;
means for automatically updating a contact list entry in response to receiving a new contact information notification text message.

12. The mobile telephone as claimed in claim 11, wherein said means for sending said new contact information notification text message comprises:
means for displaying a new contact information notification dialog, said new number notification dialog including an affirmative choice control; and,
means, responsive actuation of said affirmative choice control, for creating said new contact information notification text message.

13. The mobile telephone as claimed in claim 12, wherein said means for sending said new contact information notification text message further comprises:
means, responsive to actuation of said affirmative choice control, for displaying said contact list including a select all control and an individual selection control;
means, responsive to actuation of said select all control, for sending said new contact information notification text message to each contact mobile telephone number in said contact list; and,
means, responsive to actuation of said individual selection control, for sending said new contact information notification text message to selected contact mobile telephone numbers in said contact list.

14. The mobile telephone as claimed in claim 11, wherein said means for automatically updating said entry comprises:
means for displaying said new contact information notification text message with an update control; and,
means, responsive to actuation of said update control, for updating an entry in said contact list based upon information in said new contact information notification text message.

15. The mobile telephone as claimed in claim 11, wherein said new contact information comprises a new mobile telephone number.
